(19) United States
(12) Patent Application Publication
(10) Pub. No.: US 2010/0014192 A1
(43) Pub. Date: Jan. 21, 2010

(54) MAGNETIC RECORDING MEDIUM, MANUFACTURING METHOD THEREFOR, AND MAGNETIC RECORDING/REPRODUCING APPARATUS

(75) Inventor: Masahiro OKA, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: SHOWA DENKO K.K., Tokyo (JP)

(21) Appl. No.: 12/500,152

(22) Filed: Jul. 9, 2009

(30) Foreign Application Priority Data
Jul. 15, 2008 (JP) 2008-184211

(51) Int. Cl. G11B 5/82; G11B 5/85

(52) U.S. Cl. 360/135; 427/128; G9B/5.293

(57) ABSTRACT

A magnetic recording medium, a manufacturing method thereof, and a magnetic recording/reproducing apparatus are provided, capable, with a configuration having a magnetic recording film only on one side, of suppressing warp occurrence, and obtaining a high quality and thin-type magnetic recording medium. When forming a recording layer having at least a magnetic recording film on one main surface of a substrate by means of a vapor-phase film forming method, a thin film is formed on the other main surface of the substrate using a vapor-phase film forming method. When the recording layer is formed as a multiple layer structure, the thin film is also formed as a multiple layer structure with the same number of laminations as for the recording layer 5, and layer pairs of the same lamination order as the recording layer and the thin film are preferably formed concurrently in the same chamber.

### TECHNICAL FIELD

The present invention relates to a magnetic recording medium to be used in a hard disk device or the like that performs recording and/or reproduction on one side of a magnetic recording medium, a manufacturing method thereof, and a magnetic recording/reproducing device.

### BACKGROUND ART

In recent years, recording density has significantly improved in the area of magnetic recording media, in particular, of magnetic recording media used in a hard disk device or the like, and in particular, recording density is recently continuing to grow at a phenomenal rate, approximately 100 times in ten years.

A hard disk device is provided with: a shaft that concentrically rotates one or a plurality of laminated disk-shaped (doughnut-shaped) magnetic recording media having an opening section in the center thereof (synchronously rotated in a case of plural media); a motor that is joined via a bearing to the shaft, and that rotates the magnetic recording media; a plurality of magnetic heads that perform recording and/or reproduction on both sides of the magnetic recording medium; a plurality of supporting arms with each of the magnetic heads respectively attached thereon; and a head stack assembly that synchronously rotates the plurality of supporting arms to thereby move each magnetic head to an arbitrary position on the magnetic recording medium. That is to say, the head stack assembly is an assembly of two stacked magnetic heads in a case of a single magnetic recording medium, four stacked magnetic heads in a case of two magnetic recording media, and six stacked magnetic heads in a case of three magnetic recording media. A magnetic head for magnetic recording/reproducing is generally a floating type head, and is moved above a magnetic recording medium with a certain floating amount.

Such a magnetic recording medium equipped on a hard disk device is manufactured by sequentially forming a foundation layer, a magnetic layer, a protective layer, a lubricating layer, and the like on both surfaces of a disk-shaped substrate made, in general, of an aluminum alloy or glass substrate. Subsequently, a glide test and certifying test are sequentially performed on the obtained magnetic recording medium.

The glide test is a test for checking for the presence of protruding objects on the surface of the magnetic recording medium. That is to say, when recording/reproducing on a magnetic recording medium with use of a magnetic head, if a protrusion with a height greater than the floating amount (clearance between the medium and the magnetic head) is present on the surface of the magnetic recording medium, the magnetic head will collide with the protrusion, consequently causing damage to the magnetic head, or causing a defect in the magnetic recording medium. In a glide test, the presence of such a high protrusion is checked (for example, refer to Patent Document 1).

Moreover, a certifying test is performed on the magnetic recording medium that has passed the glide test. A certifying test is a test in which, having recorded predetermined signals on a magnetic recording medium with use of a magnetic head as with recording/reproduction performed on a generic hard disk device, the signals are reproduced and a recording inability of the magnetic recording medium is detected based on the obtained reproduced signals, to thereby evaluate the electrical characteristics of the magnetic recording medium or the product quality thereof such as defect presence (for example, refer to Patent Document 2). Therefore, a certifying test checks whether predetermined signals can be recorded/reproduced with use of a magnetic head, as with recording/reproduction in a hard disk device.

As already mentioned above, the recording density of magnetic recording media is significantly improving, and in recent products, the recording capacity of a single magnetic recording medium with a 3.5 inch outer diameter has become greater than 300 gigabytes. Moreover, hard disk devices with a high storage capacity that uses such a high density magnetic recording medium are being produced. On the other hand, there have been demands for inexpensively providing hard disk devices with a comparatively low capacity, and for further reducing the thickness of a hard disk device, and consequently there has been considered utilization of only one side of a magnetic recording medium (for example, refer to Patent Document 3). That is to say, Patent Document 3 discloses, as a method of manufacturing a magnetic disk having a magnetic layer at least on one side of a substrate, a method in which: substrates, one surface of which having a magnetic layer serves as a first main surface and on the other hand the other surface of which serves as a second main surface, are prepared; two of the substrates are laminated so that the second main surfaces are in contact with each other while the first main surfaces are on the outer side; a processing for forming magnetic recording medium is performed simultaneously on both of the first main surfaces of both of the laminated substrates; and then both of the substrates are detached from each other, to thereby simultaneously manufacture two single sided magnetic disks.

### [Prior Art Documents]

### [Patent Documents]

[Patent Document 1] Japanese Unexamined Patent Application, First Publication No. H10-105908
[Patent Document 2] Japanese Unexamined Patent Application, First Publication No. 2003-257016
[Patent Document 3] Japanese Unexamined Patent Application, First Publication No. 2001-351229

### [Problems to be Solved by the Invention]

As a method of providing a magnetic recording medium that only uses one side, there may be considered methods of: <1> using only one side of a magnetic recording medium, both sides of which are available for use; <2> using a magnetic recording medium with only one side that has passed a final test such as a certifying test; <3> forming a magnetic layer and the like only on one side of a substrate, to thereby manufacture a magnetic recording medium with only one side; and <4> laminating two substrates as disclosed in Patent Document 3, forming a magnetic layer and the like on both surfaces, and then detaching both of the substrates from each other to thereby manufacture a magnetic recording medium with only one side.

However, in a case where the method <1> is employed as a method of providing a magnetic recording medium that uses only one side, magnetic layers and the like containing expensive elements are to be formed on both sides of the substrate, and consequently product manufacturing cost cannot be reduced. In a case where the method <2> is employed, there is a problem in that the supply amount of magnetic recording media that only use one side is dependent on the rate of defect occurrence in other products, and therefore stable product supply becomes difficult. Moreover, a magnetic recording medium having a defect on one side thereof may also have an inherent cause of defects on the opposite side that has been subjected to the same processing step in some cases, and consequently the defect rate of the product may rise in some cases. In addition, in the method <2>, there is a problem similar to that in the method <1>.

The investigation carried out by the present inventor has revealed that a slight warp occurs in the magnetic recording medium in a case where the method <3> or <4> is employed. A magnetic recording medium, in general, has a structure in which on both surfaces of an aluminum alloy or glass substrate having a 2 to 3 mm thickness, there are formed thin films such as magnetic layers with a total thickness of several hundred nanometers. In a case of forming a magnetic layer and the like on the substrate surface, the substrate is heated. Therefore, it is expected that in a case where a magnetic layer and the like are formed only on one side of the substrate, a warp would occur in the magnetic recording medium due to a bimetallic effect associated with differences in thermal expansion coefficient between the substrate and the magnetic layer and the like.

However, the film thickness of the magnetic layer and the like is extremely thin with respect to the thickness of the substrate, and it is therefore highly unlikely that a warp would occur in the magnetic recording medium only due to a bimetallic effect. The present inventor investigated regarding this point, and as a result, it has been revealed that in a case where the method <3> or <4> is employed, a slight warp occurs in the magnetic recording medium due to the following reason.

When manufacturing a magnetic recording medium, an inline type film forming apparatus is used as a film forming apparatus that forms thin films such as magnetic layers on the surface of the substrate. The inline type film forming apparatus is configured having a plurality of film forming chambers connected in a circular shape. In the respective film forming chambers, there is provided a mechanism for forming thin films on both sides of the substrate by means of a sputtering method, a plasma CVD method, a plasma PVD method, or the like.

In such a film forming apparatus, carriers with substrates installed thereon are sequentially transported into the respective film forming chambers, and thin films are formed on the surface of the substrate in the respective film forming chambers, to thereby manufacture a magnetic recording medium. That is to say, in an inline type film forming apparatus, it is possible to consecutively form multiple-layer thin films on both of the surfaces of a substrate.

In a case of manufacturing a magnetic recording medium that only uses one side with use of such an inline type film forming apparatus, the film forming mechanism within the respective film forming chambers is operated so as to perform film forming only on one side, and consequently thin films are formed only on one side of the substrate by means of a sputtering method or the like.

Here, in a case where a thin film is formed on the substrate surface by means of a sputtering method or the like, plasma is generated within the reaction space. Consequently, in a case where film formation is performed only on one side of the substrate by means of a sputtering method or the like, only the one side of the substrate is exposed to the plasma. In particular, in an inline type film forming apparatus, the substrate is sequentially transported into the plurality of film forming chambers and film formation is performed within the respective film forming chambers, and consequently only the one side of the substrate is repeatedly exposed to such a film forming environment for a short period of time.

The investigation carried out by the present inventor has revealed that repetitive exposure of only one side of the substrate to such an environment is a factor that causes a warp to occur in a magnetic recording medium that has a magnetic layer and the like only on one side thereof. Moreover, it has been revealed that in a case where multiple-layer thin films are formed on the substrate, differences in composition or film forming conditions of the respective films cause differences in the film stresses (compression stress, tensile stress) of the respective films, and this is a factor that causes a warp.

### DISCLOSURE OF THE INVENTION

The present invention takes into consideration the above problems, with an object of providing a magnetic recording medium, a manufacturing method thereof, and a magnetic recording/reproducing apparatus, capable, with a configuration having a magnetic recording film only on one side, of suppressing warp occurrence and obtaining a high quality and thin magnetic recording medium.

### [Means for Solving the Problem]

The present inventor earnestly carried out studies in order to solve the above problems, and discovered that when manufacturing, with use of an inline type film forming apparatus, a magnetic recording medium having a magnetic recording film only on one side, in chambers for forming a magnetic film only on one side of a substrate, by forming a Cr thin film or a thin film, the primary component of which is Cr, on the opposite side thereof, warp occurring in the magnetic recording medium can be reduced. As a result, the present invention has been completed.
(1) A magnetic recording medium of the present invention comprising: a substrate; a recording layer in a laminated structure that is provided on one main surface of the substrate and that is formed with a plurality of layers at least having a magnetic recording film; and a thin film in a laminated structure not for magnetic recording that is provided on the other main surface of the substrate and that is formed with a plurality of layers, the primary component of which is Cr.
(2) The magnetic recording medium of the present invention comprises the thin film in a laminated structure, the primary component of which is Cr, have a film thickness substantially equal to that of the recording layer.
(3) The magnetic recording medium of the present invention wherein the respective layers that constitute the thin film in a laminated structure, the primary component of which is Cr, respectively have a film thickness substantially equal to that of the layer of the same lamination order among the respective layers that constitute the laminated recording layer.
(4) The magnetic recording medium of the present invention wherein the recording layer in a laminated structure has; a soft magnetic layer, a non-magnetic layer, a soft magnetic layer, a seed layer, an intermediate layer, and a magnetic layer, laminated in this order, and the thin film in a laminated structure, the primary component of which is Cr, is of a laminated structure formed with; a layer having a film thickness substantially equal to that of the soft magnetic layer, a layer having a film thickness substantially equal to that of the non-magnetic layer, a layer having a film thickness substantially equal to that of the soft magnetic layer, a layer having a film thickness substantially equal to that of the seed layer, and a layer having a film thickness substantially equal to that of the intermediate layer and magnetic layer.
(5) A method of manufacturing a magnetic recording medium of the present invention is a method of manufacturing a magnetic recording medium in which a recording layer in a laminated structure at least having a magnetic recording film is formed by means of a vapor-phase film forming method using a plurality of chambers, wherein, when forming the recording layer in a laminated structure on one main surface of a substrate with use of a plurality of chambers, a thin film in a laminated structure, the primary component of which is Cr, is concurrently formed on an other main surface of the substrate using a vapor-phase film forming method.
(6) The method of manufacturing a magnetic recording medium of the present invention, wherein with use of a plurality of connected film forming chambers, a substrate is sequentially transported into the respective film forming chambers, and at this time, in the respective film forming chambers, respective layers that constitute the recording layer in a laminated structure and respective layers that constitute the thin film in a laminated structure, the primary component of which is Cr, are concurrently formed, to thereby form the recording layer in the laminated structure and the thin film in a laminated structure, the primary component of which is Cr.
(7) The method of manufacturing a magnetic recording medium of the present invention wherein, when concurrently forming the respective layers that form the recording layer in a laminated structure and the respective layers that constitute the thin film in a laminated structure, the primary component of which is Cr, according to (6), the respective layers to be manufactured in the same chamber are formed with a substantially equal film thickness.
(8) The method of manufacturing a magnetic recording medium of the present invention, wherein a primary component of the substrate is either crystallized glass or amorphous glass.
(9) The method of manufacturing a magnetic recording medium of the present invention comprising a combination of: a magnetic recording medium according to any one of (1) to (4); a driving section that drives the magnetic recording medium in a recording direction; a magnetic head formed with a recording section and a reproducing section; a head driving section that relatively moves the magnetic head with respect only to one side of the magnetic recording medium; and a recording/reproduction signal processing device that inputs signals to the magnetic head and reproduces output signals from the magnetic head.

### [Effect of the Invention]

A magnetic recording medium of the present invention is of a configuration having a magnetic recording film only on one side and is capable of suppressing warp occurrence, and it enables acquisition of high quality and thin magnetic recording medium.

Moreover, according to the method of manufacturing a magnetic recording medium of the present invention, it is possible to provide such a magnetic recording medium at a high level of productivity.

Furthermore, with use of such a magnetic recording medium, it is possible to provide a thin and inexpensive hard disk device.

### BRIEF DESCRIPTION OF THE DRAWINGS

FIG. 1 is a vertical sectional view showing an embodiment of a magnetic recording medium of the present invention.

FIG. 2 is a schematic drawing showing a magnetic recording medium manufacturing apparatus used in a method of manufacturing a magnetic recording medium of the present invention.

FIG. 3 is a schematic drawing showing sputter chambers and carriers provided in the magnetic recording medium manufacturing apparatus shown in FIG. 2.

FIG. 4 is a side view showing the carrier provided in the magnetic recording medium manufacturing apparatus shown in FIG. 2.

FIG. 5 is a schematic configuration drawing showing an example of a magnetic recording/reproducing device of the present invention.

### BEST MODE FOR CARRYING OUT THE INVENTION

Hereunder, there is described an embodiment of a magnetic recording medium according to the present invention.

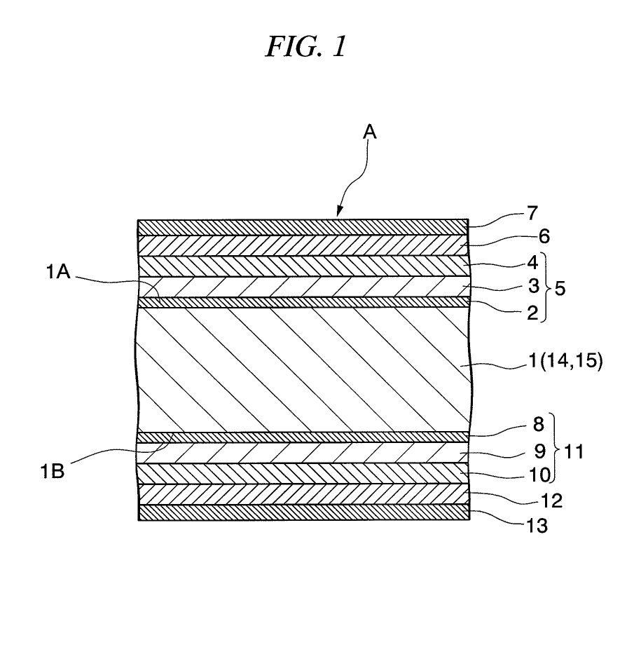

FIG. 1 is a schematic vertical sectional view showing an embodiment of a magnetic recording medium (thin film laminated body).

As shown in FIG. 1, a magnetic recording medium A of this embodiment, for example, has a substrate 1, a recording layer 5 provided on one principal surface 1A of the substrate 1, and a thin film 11, the primary component of which is Cr, provided on the other main surface 1B of the substrate 1.

As the substrate 1, in addition to an Al alloy substrate (NiP-plated Al substrate) generally used as a substrate for a magnetic recording medium having a NiP-plating film formed thereon, there may be used a glass substrate, a ceramic substrate, a flexible resin substrate, or a substrate in which NiP is plated or deposited by means of a sputtering method on these substrates. Among these substrates, the effect of the present invention emerges significantly, particularly in a case of using a substrate, the primary component of which is a crystallized glass or amorphous glass. The reason for this is as follows.

That is to say, a crystallized glass substrate or an amorphous glass substrate has a lower thermal conductivity compared to an Al alloy. Consequently, when forming the recording layer 5, in a case where film formation is performed in a film forming chamber of a chamber by means of the method described later, if only one side of the substrate 1 (one main surface 1A) is heated with plasma generated within the film forming chamber, particularly the crystalline structure of only one side becomes likely to be modified, and a warp is likely to occur.

On the other hand, with a configuration in which the recording layer 5 is provided on the one main surface 1A of the substrate 1 and the thin film 11 is provided on the other main surface, it is possible to perform manufacturing using a step in which the thin film 11 is concurrently formed while the recording layer 5 is being formed. In this case, when forming the recording layer 5, the main surfaces 1A and 1B of the substrate 1 are both exposed to plasma, and therefore even with a crystallized glass substrate or an amorphous glass substrate, crystalline structures are modified similarly on both sides of the substrate 1, and it is consequently possible to reliably suppress a warp therein.

The recording layer 5 is configured with a magnetic recording film 4 and a seed layer that is provided as necessary.

The recording layer 5 is an in-plane magnetic recording layer or a perpendicular magnetic recording layer. However, a perpendicular magnetic recording layer is preferable in order to realize a further higher recording density.

Specific examples of the in-plane magnetic recording layer include a laminated structure formed with a seed layer, the primary material of which is a non-magnetic CrMo based alloy, and the magnetic recording film 4, the primary material of which is a ferromagnetic CoCrPtTa based alloy.

The perpendicular magnetic recording layer is, for example, of a laminated structure in which; a backing layer 2, an orientation control film 3, and the magnetic recording film 4 are laminated in this order. Moreover, between the orientation control film 3 and the magnetic layer, there may be provided an intermediate film. In this case, the backing layer 2 and the orientation control film 3, or the backing layer 2, the orientation control film 3 and the intermediate film constitute the seed layer.

The backing layer 2 is constituted by a soft magnetic material. Specific examples of the soft magnetic material to be used for the backing layer 2 include; FeCo based alloy (FeCoB, FeCoSiB, FeCoZr, FeCoZrB, FeCoZrBCu, or the like), FeTa based alloy (FeTaN, FeTaC, or the like), and Co based alloy (CoTaZr, CoZrNB, CoB, or the like).

Specific examples of the material of the orientation control film 3 include Pt, Pd, NiCr, NiFeCr, and the like, and specific examples of the material of the intermediate film include Ru and the like.

Specific examples of the material of the magnetic recording film 4 include; CoCrPt based alloy, FePt based alloy, CoPt based alloy, FePd based alloy, CoPd based alloy, and the like, and there may be used one having an added oxide for turning these magnetic layers into a granular structure. Moreover, these alloy metal layers may be of a multiple layer structure. Among these multiple layer structures, it is preferable that the primary component is configured by FePt based alloy. Specific examples of FePt based alloy to be used in the magnetic layer include, 12Cr-36Fe-52Pt, 25Fe-30Co-45Pt, 38Fe-10Co-5Ni-47Pt, and the like.

Moreover, the magnetic recording film 4 may have, as a grain boundary formation substance that forms a granule structure, an oxide added therein. A preferred oxide that forms the granule structure is one that includes any one or more types of Si oxide, Ti oxide, W oxide, Cr oxide, Co oxide, Ta oxide, and Ru oxide.

The recording layer 5 described above, while taking into consideration the type of a magnetic alloy to be used and the laminated structure, may be formed under a condition where sufficient head output/input can be obtained. For example, as for the film thickness of the magnetic layer, in order to obtain more than a certain level of output when reproducing, more than a certain thickness is required. On the other hand, various parameters that serve as indexes of recording/reproduction characteristic usually get degraded as the output rises. From this point of view, the magnetic layer needs to be formed with an optimum film thickness. Specifically, the thickness of the magnetic recording layer is preferably not less than 3 nm and not greater than 20 nm, and is further preferably not less than 5 nm and not greater than 15 nm.

Moreover, in the magnetic recording medium of the present embodiment, on the recording layer 5 described above there is provided a protective film 6, and on the surface of the protective film 6 there is provided a lubricating agent layer 7.

The protective film 6 has a function to prevent damage associated with a magnetic head contacting with the medium surface.

As the protective film 6, for example, there may be used a film having a single component C, SiO₂, ZrO₂ or the like, or a film with any one of these as a primary component thereof, containing an additive element.

The protective film 6 can be formed by means of the sputtering method, ion beam method, plasma CVD method, or the like.

The thickness of the protective film 6 is generally 1 to 10 nm. Furthermore, the preferable thickness of the protective film 6 is 1 to 5 nm, because loss of spacing between the magnetic head and the recording layer can be made small when performing recording and/or reproduction on the magnetic recording medium.

On the surface of the protective film 6 there is formed the lubricating agent layer 7.

As the lubricating agent, a fluoride based liquid lubricating agent such as perfluoroether (PFPE), or a solid lubricating agent such as fatty acid, is used. As a lubricating agent application method, a commonly known method such as a dipping method and a spin-coat method may be used.

On the other hand, the thin film 11, the primary component of which is Cr, is provided on the other main surface 1B of the substrate 1. This thin film 11 has a first Cr film 8, a second Cr film 9, and a third Cr film 10, and is configured such that these respective layers 8, 9, and 10 are laminated in this order on the substrate 1.

The first Cr film 8 to the third Cr film 10 are thin films the primary component of which is Cr, and may be constituted by pure Cr (100% Cr) or an alloy containing 50 atomic percent of Cr. Cr or an alloy, the primary component of which is Cr, is inexpensive compared to noble metals or rare metals, and is an element that is also commonly used for the recording layer 5, providing an advantage of having less influence on the magnetic recording film 4 on the opposite side of the substrate 1. In addition, Cr is selected here because, Cr, in general, is considered as a material with a high level of adhesiveness having a low risk when being detached, and moreover the film stress thereof is close to that of the material of the recording layer 5.

It is preferable that the first Cr film 8 to the third Cr film 10 respectively have a thickness substantially equal to that of the layer of the same lamination order among the respective layers constituting the recording layer 5. That is to say, it is preferable that the first Cr film 8 have a film thickness substantially equal to that of the seed layer 2, the second Cr film 9 have a film thickness substantially equal to that of the seed layer 3, and the third Cr film 10 have a film thickness substantially equal to that of the magnetic recording film 4. Thus, when forming these respective layers on the surface of the substrate 1, both sides of the substrate 1 are exposed to plasma only for substantially the same amount of time. As a result, the crystalline structure is modified substantially equally on both sides of the substrate 1, and it is consequently possible to reliably suppress a warp occurring therein. In the present invention, a substantially equal film thickness includes an approximate film thickness difference plus or minus 50% of the respective films in a case of forming films so as to correspond to both sides of the substrate 1. However, a further preferable film thickness difference falls within a range of approximately plus or minus 30% from an aspect of an effect of suppressing the amount of warp in the substrate.

Moreover, in the magnetic recording medium of the present embodiment, on the thin film 11 described above there is provided a protective film 12, and on the surface of the protective film 12 there is provided a lubricating agent layer 13.

The protective film 12 may have a configuration similar to that of the protective film 6 provided on the recording layer 5 described above. The protective film 6 having the above described configuration, has a function for preventing damage to the magnetic recording medium when the magnetic head comes in contact with the surface of the magnetic recording medium. Therefore, the protective film 12 may be omitted on the thin film 11 side on which the magnetic head does not travel, and instead there may be provided a thin film, the primary component of which is Cr.

Moreover, the lubricating agent layer 13 may have a configuration similar to that of the lubricating agent layer 7 provided on the surface of the protective film 6 described above.

Thus, the magnetic recording medium of the present embodiment is such that on the one main surface 1A of the substrate 1 there are provided the seed layer 2, the seed film 3, the magnetic recording film 4, and the protective film 6, and on the other main surface 1B there are provided the first Cr film 8, the second Cr film 9, the third Cr film 10, and the protective film 12. In the magnetic recording medium having such a configuration, in the manufacturing steps thereof, for example, there can be respectively concurrently formed: the first Cr film 8 is formed within the same chamber as that of the seed layer 2; the second Cr film 9 is formed within the same chamber as that of the seed film 3; the third Cr film 10 is formed within the same chamber as that of the magnetic recording film 4; and the protective film 12 is formed within the same chamber as that of the protective film 6.

The lubricating agent layer 13 may be formed in the same structure as that of the lubricating agent layer 7 formed on the above-described protective layer 6.

In this case, in the respective film forming steps, both surfaces of the substrate 1 are exposed to plasma, and heating and cooling are repeatedly performed on both surfaces of the substrate 1. As a result, the crystalline structure in the thickness direction of the substrate 1 is modified on both sides of the substrate 1, and it is consequently possible to reduce warp occurring in the substrate 1.

Moreover, in the present invention, on the side of the magnetic recording medium not to be used for magnetic recording (on the other main surface 1B side), there is used a single composition film with Cr, which is a comparatively inexpensive element, or an alloy thin film, the primary component of which is Cr, and it is consequently possible to reduce manufacturing cost for the magnetic recording medium, compared to the case of providing recording layers on both sides of the substrate.

“Method of Manufacturing a Magnetic Recording Medium”

Next, there is described a method of manufacturing a magnetic recording medium of the present invention, with an example of a case of manufacturing the magnetic recording medium shown in FIG. 1.

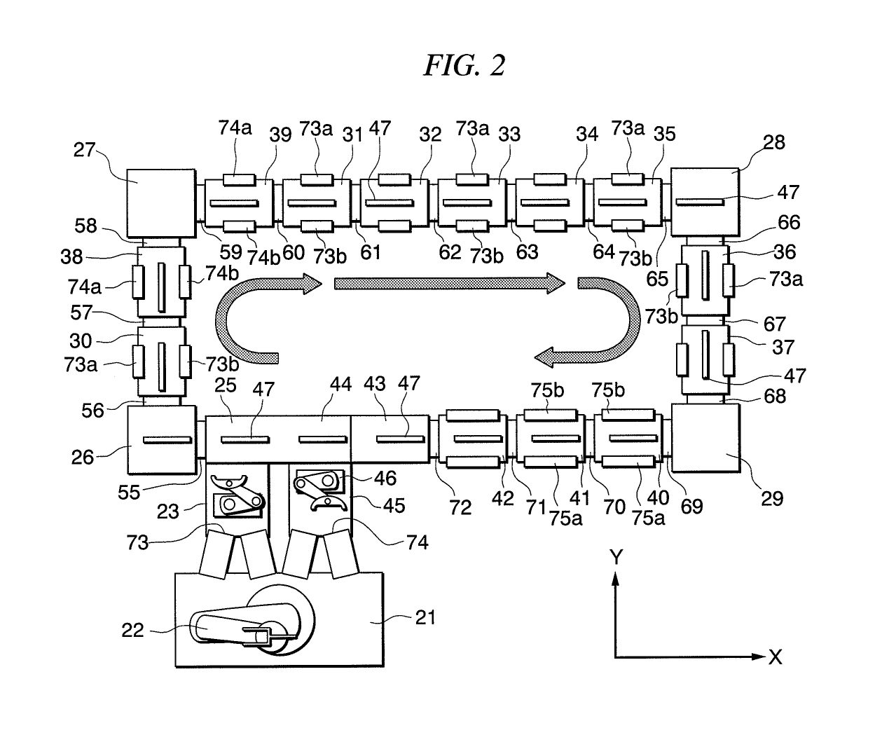

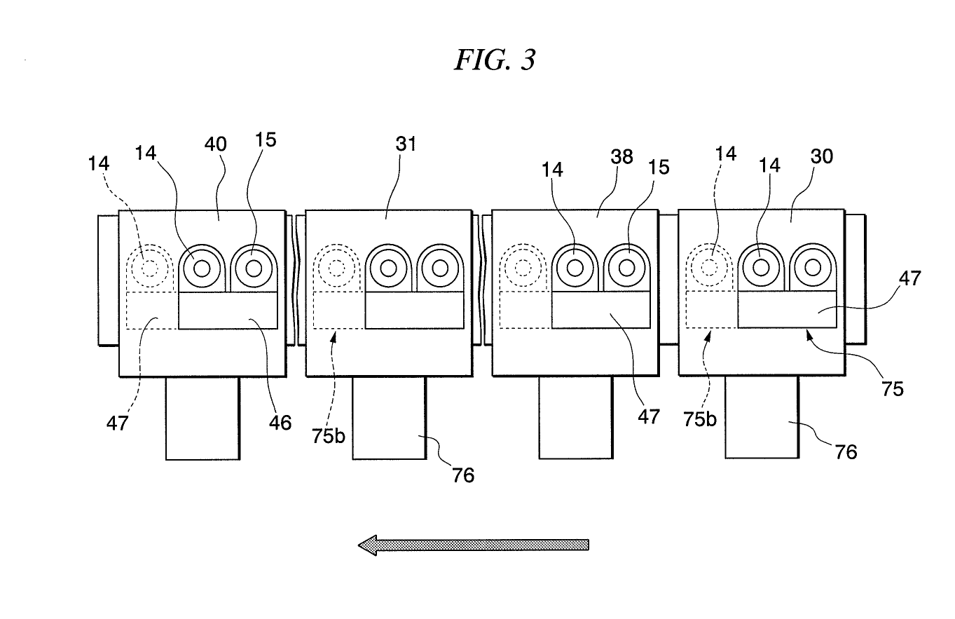

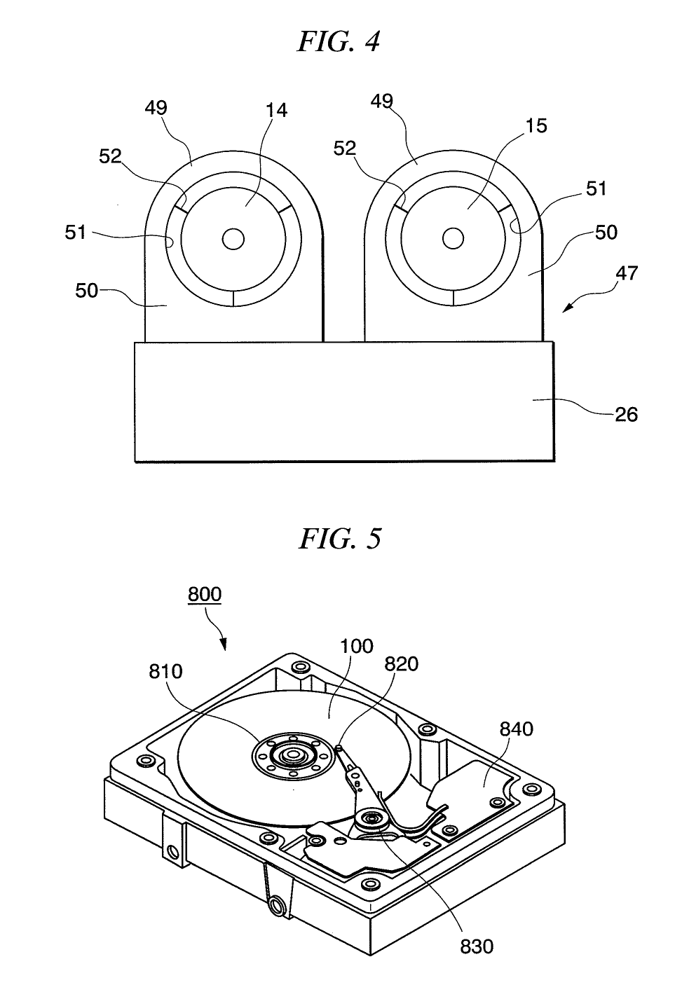

FIG. 2 is a schematic drawing showing an example of a magnetic recording medium manufacturing apparatus of the present invention, FIG. 3 is a schematic drawing showing sputter chambers and carriers provided in the magnetic recording medium manufacturing apparatus of the present invention, and FIG. 4 is a side view showing the carrier provided in the magnetic recording medium manufacturing apparatus of the present invention. In FIG. 3, a carrier 47 shown with a solid line represents a state of being stopped in a first film forming position, and a carrier 47 shown with a broken line represents a state of being stopped in a second film forming position.

The magnetic recording medium manufacturing apparatus shown in FIG. 2 is configured as an inline type film forming apparatus. This magnetic recording medium manufacturing apparatus has: a substrate cassette transferring robot base 21; a substrate cassette transferring robot 22; a substrate supplying robot chamber 23; a substrate supplying robot 24; a substrate attaching chamber 25; corner chambers 26, 27, 28, and 29 for rotating the carriers; sputter chambers 30, 31, 32; 33, 34, 35, 36, and 37; substrate heating chambers 38 and 39; protective film forming chambers 40, 41, and 42; a substrate detaching chamber 43; a carrier ashing chamber 44; a substrate detaching robot chamber 45; a substrate detaching robot 46; and a plurality of carriers 47 on which a plurality of film forming substrates (substrates) 14 and 15 are installed.

To these respective chambers 23, and 25 to 45, there are respectively connected vacuum pumps 76 (refer to FIG. 3), and the carriers 47 are sequentially transported into the respective chambers that are decompressed by operation of these vacuum pumps 76. In the respective sputter chambers 30 to 37 and in the respective protective film forming chambers 40 to 42, a thin film is formed on both sides of the respective film forming substrates 14 and 15 installed on the carriers 47 (for example, the seed layer 2, the seed film 3, the magnetic recording film 4, and the protective film 6 on the one main surface, and the first Cr film 8 to the third Cr film 10, and the protective film 12 on the other main surface), to thereby manufacture a magnetic recording medium. In FIG. 2, the carrier 47 is sequentially transported and supplied to the respective chambers 23 and 25 to 44, and therefore the carriers 47 are illustrated with solid lines for descriptive purposes.

Moreover, in this magnetic recording medium manufacturing apparatus, it is possible to form the seed layer 2, the seed film 3, the magnetic recording film 4, and the protective film 6 on the one main surface 1A of the respective film forming substrates 14 and 15, respectively in necessary lamination structures, namely, two-layer configuration, two-layer configuration, four-layer configuration, and three-layer configuration. Furthermore, it is possible to form the first Cr film 8 to the third Cr film 10, and the protective film 12 on the other main surface 1B of the respective film forming substrates 14 and 15, respectively in layer configurations similar to those of the seed layer 2, the seed film 3, the magnetic recording film 4, and the protective film 6, that is, necessary lamination structures namely, two-layer configuration, two-layer configuration, four-layer configuration, and three-layer configuration. However, the lamination structures are not limited to these examples, and may be configured by adding a required number of chambers according to the magnetic recording medium of the necessary lamination structure.

As shown in FIG. 4, the carrier 47 has a supporting base 48, and a plurality of substrate installation sections 49 (two of these installed in the present embodiment) provided on the upper surface of the supporting base 48.

The substrate installation section 49 is configured such that as shown in FIG. 4, in a plate body 50 having a thickness approximately several fold greater than the thickness of the respective film forming substrates (substrates) 14 and 15, there is formed a circular through hole 51 with a diameter slightly greater than the outer circumference of the respective film forming substrates 14 and 15, and around the through hole 51 there are provided a plurality of supporting members 52 that project toward the inner side of the through hole 51. On this substrate installation section 49, the film forming substrates 14 and 15 are fitted within the through hole 51, by the substrate supplying robot 24 described later, and the supporting members 52 engage with the edge section thereof to thereby hold the film forming substrates 14 and 15. These substrate installation sections 49 are provided in a line on the upper surface of the supporting base 48 so that the main surfaces of the two of the installed film forming substrates 14 and 15 are substantially orthogonal to the upper surface of the supporting base 48 while being on substantially the same plane. Hereunder, two of the film forming substrates 14 and 15 to be installed on these substrate installation sections 49 are respectively referred to as the first film forming substrate 14 and the second film forming substrate 15.

The substrate cassette transferring robot 22 takes out the two film forming substrates 14 and 15 from a cassette (not shown in the drawing) housing a plurality of film forming substrates therein, and supplies them to the substrate supplying robot chamber 23, and it takes out a magnetic disk (the respective film forming substrates 14 and 15 with the recording layer 5, the thin film 11, and the protective films 6 and 12 formed thereon) that has been taken out in the substrate detaching robot chamber 45. On one side wall of the substrate supplying robot chamber 23 and the substrate detaching robot chamber 45, there are respectively provided an opening that opens to the outside and doors 73 and 74 that open and close this opening. Through these openings, the respective film forming substrates 14 and 15 are transported into and from the respective chambers 23 and 45.

Moreover, the respective chambers 45 to 43 are connected in the order of: the substrate attaching chamber 25; the corner chamber 26; the sputter chamber 30; the substrate heating chamber 38; the corner chamber 27; the substrate heating chamber 39; the sputter chambers 31 to 35; the corner chamber 28; the sputter chambers 36 and 37; the corner chamber 29; the protective film forming chambers 40 to 42; and the substrate detaching chamber 43. Moreover, at the respective connection sections between the adjacent chambers, there are respectively provided gate valves 55 to 72. In a state where these gate valves 55 to 72 are closed, the inside of the respective chambers are respectively independent enclosed spaces.

The respective corner chambers 26 to 29 are chambers for changing the movement direction of the carrier 47, and inside thereof, there is provided a mechanism (not shown in the drawing) that rotates the carrier 47 to change the orientation thereof and moves it to the next chamber.

The respective sputter chambers 30 to 37 respectively are chambers in which a thin film is formed on both of the main surfaces 1A and 1B of the first film forming substrate 14 and the second film forming substrate 15, by means of a sputtering method. In the respective sputter chambers 30 to 37, inside thereof there are provided a recording layer forming target 73a and a Cr target 73b facing each other, and moreover, a sputter gas supplying pipe (not shown in the drawing) and the vacuum pump 76 are connected thereto.

Here, in the present embodiment, as the recording layer forming target 73a, in the sputter chambers 30 and 31 there is arranged a target that corresponds to the composition of the seed layer 2, in the sputter chambers 32 and 33 there is arranged a target that corresponds to the composition of the seed film 3, and in the sputter chambers 34 to 37 there is arranged a target that corresponds to the composition of the magnetic recording film 4. In the substrate heating chambers 38 and 39 there are respectively provided heating heaters 74a and 74b.

Moreover, in the respective sputter chambers 30 to 37, there are set a first film forming position 75 (position shown with a solid line in FIG. 3) and a second film forming position 75b (position shown with a broken line in FIG. 3) where the carrier 47 stops.

As shown in FIG. 3, in such respective sputter chambers 30 to 37, when the carrier 47 that has been transported into the chamber stops at the first film forming position 75, an electric voltage is applied to an electrode within the chamber to thereby generate plasma, and sputtered particles generated from the target 73a are adhered on the one main surface 1A of the first film forming substrate 14. Thereby, the respective thin films that constitute the recording layer 5 are formed on the one main surface 1A of the first film forming substrate 14. Moreover, sputtered particles generated from the Cr target 73b are adhered on the other main surface 1B of the first film forming substrate 14. Thereby, the respective thin films that constitute the thin film 11 are formed on the other main surface 1B of the first film forming substrate 14. Moreover, when the carrier 47 has moved from the first film forming position 75 to the second film forming position 76, the respective thin films that constitute the thin film 11 are similarly formed on the one main surface 1A and the other main surface 1B of the second film forming substrate 15.

In FIG. 3, the sputter chambers 30 and 31 among the sputter chambers 30 to 37 are shown as representatives.

Moreover, in the present embodiment, a pair of the recording layer forming target 73a and the Cr target 73b are arranged within the respective sputter chambers 30 to 37. However, two pairs of the respective targets 73a and 73b may be provided. In this case, the movement of the carrier 47 from the first film forming position 75 to the second film forming position 75b is not necessary, and in a state where the carrier 47 is stopped in a predetermined position, thin films can be concurrently formed on both of the main surfaces 1A and 1B of the first film forming substrate 14 and on both of the main surfaces 1A and 1B of the second film forming substrate 15.

The respective substrate heating chambers 38 and 39 are respectively chambers in which the first film forming substrate 14 and the second film forming substrate 15 having the thin film formed thereon, are heated.

The respective protective film forming chambers 40 to 42 are respectively chambers in which the respective protective films 6 and 12 are formed, by means of a CVD method or the like, on the surface of the uppermost layer formed on both of the main surfaces 1A and 1B of the first film forming substrate 14 and the second film forming substrate 15.

The carrier ashing chamber 44 is a chamber in which the carrier, from which the respective film forming substrates 14 and 15 have been detached, is subjected to an ashing processing. The ashing-processed carrier 47 is supplied again to the film forming step described above. That is to say, the ashing-processed carrier 47 is transported into the substrate attaching chamber 25 and has two of the film forming substrates 14 and 15 installed thereon, and is then transported into the respective chambers 26 to 43, to thereby respectively form, in necessary lamination structures, the recording layer 5, the thin film 11, and the protective films 6 and 12 on the surface of the respective film forming substrates 14 and 15.

Through the above steps, the seed layer 2, the seed film 3, and the magnetic recording film 4 are formed on the one main surface 1A of the respective film forming substrates 14 and 15, and the first Cr film 8 to the third Cr film 10 are formed on the other main surface 1B.

Having completed these steps, a lubricating agent is separately applied, by means of a dipping method, a spin-coat method, or the like, on the surface of the respective protective films 6 and 12 to thereby form the lubricating agent layers 7 and 13. As a result, a magnetic recording medium is obtained.

In order to form, on the surface of the film forming substrates, the respective thin films that constitute the recording layer, the protective films, and the like as described above, a sputtering method, a plasma CVD method, a plasma PVD method, and the like are used. However, if thin films are formed only on one side of the film forming substrate using these film forming methods, only the one side of the film forming substrate will be exposed to plasma. Moreover, since thin films are formed in a plurality of layers on the surface of the film forming substrate, only the one side of the film forming substrate is to be repeatedly exposed to such plasma.

The investigation carried out by the present inventor has revealed that this is a factor that causes a warp to occur in a magnetic recording medium. The reason therefor is thought to be that if only one side of the film forming substrate is repeatedly heated with plasma, heating and cooling are repeatedly performed on the one side of the film forming substrate, and consequently the crystalline structure in the thickness direction is modified only on one side of the film forming substrate.

On the other hand, in the present invention, when forming, on one side of the respective film forming substrates 14 and 15, the respective films that constitute the recording layer 5, a Cr thin film 11 or a thin film 11 having Cr as the primary component thereof, is concurrently formed on the opposite surface. Consequently, in the respective film forming steps, both sides of the respective film forming substrates 14 and 15 are exposed to plasma, and heating and cooling are repeatedly performed on both sides of the film forming substrates 14 and 15. As a result, the modified crystalline structure in the thickness direction of the respective film forming substrates 14 and 15, becomes the same structure on the right and left sides, and it is consequently possible to reduce warp occurrence in the film forming substrates.

Moreover, in the present invention, on the side of the magnetic recording medium not to be used for magnetic recording (on the other main surface 1B side), there is used a single composition film with Cr, which is a comparatively inexpensive element, or an alloy thin film, the primary component of which is Cr, and it is consequently possible to reduce manufacturing cost for the magnetic recording medium using a comparatively inexpensive Cr or Cr based alloy, without using a noble metal or rare earth metal, compared to the configuration of providing recording layers on both sides of the substrate.

The embodiment of the magnetic recording medium and the manufacturing method thereof of the present invention, have been described. However, the configuration of the present invention is not limited to this.

For example, in the present embodiment, the recording layer is configured with the seed layer, the seed film, and the magnetic recording film, however, other configurations may be possible. For example, if the recording layer is configured so as to have an AFC structure in which a soft magnetic film, a non-magnetic film (AFC (antiferromagnetic coupling) layer), and a soft magnetic film are laminated, the recording density can be further increased. Specific examples of recording layers having such an AFC structure include one with a seed layer, an intermediate layer, and a magnetic layer further laminated in this order on a lamination having such an AFC structure.

In this case, as the magnetic recording medium manufacturing apparatus used for manufacturing a magnetic recording medium, except that it is provided with a number of sputter chambers so as to correspond to the layer configuration of the recording layer, and recording layer forming targets of the respective sputter chambers that correspond to the composition of the respective thin films that constitute the recording layer are used, there may be used one similar to the inline type film forming apparatus shown in FIG. 2.

FIG. 5 shows an example of a magnetic recording/reproducing apparatus using the magnetic recording medium according to the present invention.

This magnetic recording/reproducing apparatus 800 is provided with: a magnetic recording medium 100 obtained by the above method; a medium driving section 810 that rotation-drives the magnetic recording medium 100; a magnetic head 820 that records/reproduces information on one side of the magnetic recording medium 100; a head driving section 830; and a recording/reproduction signal processing system (recording/reproduction signal processing device) 840. The recording/reproduction signal processing system 840 is capable of processing input data, transmitting recording signals to the magnetic head 820, processing reproduction signals from the magnetic head 820, and outputting data.

The magnetic recording/reproducing apparatus 800 of the present invention is of a thin type because it has the magnetic head 820 only on one side of the magnetic recording medium 100. Moreover, according to the present invention, the number of components in the magnetic head 820, the head driving section 830, and the recording/reproduction signal processing system 840, can be reduced, and it is consequently possible to provide an inexpensive magnetic recording/reproducing apparatus.

### WORKING EXAMPLES

Hereunder, there are described working examples of the present invention. However, the present invention is not limited to these working examples.

### Working Example 1

A magnetic recording medium was manufactured, using an apparatus similar to the inline type film forming apparatus shown in FIG. 2, except that it was provided with a number of sputter chambers so as to correspond to the layer configuration shown below, and recording layer forming targets of the respective sputter chambers that correspond to the composition of the following respective layers, were used.

The manufactured magnetic recording medium was such that on one main surface of an NiP-plated aluminum substrate having a 3.5 inch outer diameter, there were laminated-formed: a first soft magnetic layer (thickness 300 nm) formed with 66Co30Fe4Zr; an AFC layer (thickness 7 nm) formed with Ru; a second soft magnetic layer (thickness 300 nm) formed with 66Co30Fe4Zr; a seed layer (thickness 10 nm) formed with 90Ni10W; an intermediate layer (thickness 100 nm) formed with Ru; a first magnetic layer (thickness 80 nm) formed with 59Co17Cr16Pt-8(SiO₂); a second magnetic layer (thickness 100 nm) formed with 65Co21Cr14Pt; and a 5 nm carbon protective film, and on the other main surface there were laminated-formed: a first Cr film (thickness 10 nm); a second Cr film (thickness 7 nm); a third Cr film (thickness 300 nm); a fourth Cr film (thickness 10 nm); a fifth Cr film (thickness 100 μm); a sixth Cr film (thickness 80 nm); a seventh Cr film (thickness 100 nm); and a 5 nm carbon protective film.

Here, the first soft magnetic layer and the first Cr film, the AFC layer and the second Cr film, the second soft magnetic layer and the third Cr film, the seed layer and the fourth Cr film, the intermediate layer and the fifth Cr film, the first magnetic layer and the sixth Cr film, and the second magnetic layer and the seventh Cr film, were respectively formed in the same sputter chamber. Moreover, the carbon protective films were formed by means of a plasma CVD method.

Having manufactured the magnetic recording medium, the warp that occurred in the magnetic recording medium was measured. A three-dimensional shape measuring device manufactured by Mitutoyo Corporation was used to measure the warp.

As a result of the measurement, the magnetic recording medium manufactured in the present working example had a maximum of 10 nm warp with a convex on the magnetic recording film side.

### Working Example 2

A magnetic recording medium was manufactured under conditions similar to those in the working example 1, except that a crystallized glass substrate having a 2.5 inch outer diameter, the components of which were Li₂Si₂O₅, Al₂O₃—K₂O, Al₂O₃—K₂O, MgO—P₂O₅, and Sb₂O₃—ZnO, was used as a substrate.

The magnetic recording medium manufactured in the present working example had a maximum of 5 nm warp with a convex on the magnetic recording film side.

### Working Example 3

A magnetic recording medium was manufactured under conditions similar to those in the working example 1, except that the first to seventh Cr films in the previous working example 2 were respectively increased in film thickness by +30%. This magnetic recording medium had a 55 nm warp with a concave on the magnetic recording film side.

### Working Example 4

A magnetic recording medium was manufactured under conditions similar to those in the working example 1, except that the first to seventh Cr films in the previous working example 2 were respectively decreased in film thickness by −30%. This magnetic recording medium had a 55 nm warp with a convex on the magnetic recording film side.

### Working Example 5

A magnetic recording medium was manufactured under conditions similar to those in the working example 1, except that the first to seventh Cr films in the previous working example 2 were respectively increased in film thickness by +50%. This magnetic recording medium had a 70 nm warp with a concave on the magnetic recording film side.

### Working Example 6

A magnetic recording medium was manufactured under conditions similar to those in the working example 1, except that the first to seventh Cr films in the working example 2 were respectively decreased in film thickness by −50%. This magnetic recording medium had a 70 nm warp with a convex on the magnetic recording film side.

### Comparative Example 1

A magnetic recording medium was manufactured under conditions similar to those in the working example 1, except that the first Cr film to the seventh Cr film were not provided on the other main surface of the substrate.

The magnetic recording medium manufactured in this comparative example had a maximum of 150 nm warp with a convex on the magnetic recording film side.

### Comparative Example 2

A magnetic recording medium was manufactured under conditions similar to those in the working example 2, except that the first Cr film to the seventh Cr film were not provided on the other main surface of the substrate.

The magnetic recording medium manufactured in this comparative example had a maximum of 250 nm warp with a convex on the magnetic recording film side.

### INDUSTRIAL APPLICABILITY

The present invention has a configuration having a magnetic recording film only on one side while suppressing warp occurrence, and it is consequently possible to manufacture a thin and high-quality magnetic recording medium and magnetic recording/reproducing apparatus.

### [Description of Reference Symbols]

1: Substrate, 1A: one main surface, 1B: other main surface, 2: seed layer, 3: seed film, 4: magnetic recording film, 5: recording layer, 6: protective film, 7: lubricating agent layer, 8: first Cr film, 9: second Cr film, 10: third Cr film, 11: recording layer, 12: protective film, 13: lubricating agent layer, 14: first film forming substrate, 15: second film forming substrate, 30 to 37: sputter chamber, 38 and 39: substrate heating chamber, 40 to 42: protective film forming chamber, 47: carrier, 800: magnetic recording/reproducing apparatus, 100: magnetic recording medium, 810: medium driving section, 820: magnetic head, 830: head driving section, and 840: recording/reproduction signal processing system.

1. A magnetic recording medium comprising: a substrate; a recording layer in a laminated structure that is provided on one main surface of said substrate and that is formed with a plurality of layers at least having a magnetic recording film; and a thin film in a laminated structure not for magnetic recording that is provided on an other main surface of said substrate and that is formed with a plurality of layers, the primary component of which is Cr.

2. A magnetic recording medium according to claim 1, wherein said thin film, the primary component of which is Cr, has a film thickness substantially equal to that of said recording layer.

3. A magnetic recording medium according to claim 1, wherein the respective layers that constitute said thin film, the primary component of which is Cr, respectively have a film thickness substantially equal to that of the layer of the same lamination order among the respective layers that constitute said recording layer.

4. A magnetic recording medium according to claim 1, wherein said recording layer comprises; a soft magnetic layer, a non-magnetic layer, a soft magnetic layer, a seed layer, an intermediate layer, and a magnetic layer, in this order, and said thin film in the laminated structure, the primary component of which is Cr, is of a laminated structure formed with; a layer having a film thickness substantially equal to that of said soft magnetic layer, a layer having a film thickness substantially equal to that of said non-magnetic layer, a layer having a film thickness substantially equal to that of said soft magnetic layer, a layer having a film thickness substantially equal to that of said seed layer, and a layer having a film thickness substantially equal to that of said intermediate layer and magnetic layer.

5. A method of manufacturing a magnetic recording medium in which a recording layer in a laminated structure at least having a magnetic recording film is formed by means of a vapor-phase film forming method using a plurality of chambers, wherein,
when forming said recording layer in the laminated structure on one main surface of a substrate with use of a plurality of chambers, a thin film in a laminated structure, the primary component of which is Cr, is concurrently formed on an other main surface of said substrate using a vapor-phase film forming method.

6. A method of manufacturing a magnetic recording medium according to claim 5, wherein with use of a plurality of connected film forming chambers, a substrate is sequentially transported into said respective film forming chambers, and at this time, in said respective film forming chambers, respective layers that constitute said recording layer and respective layers that constitute said thin film, the primary component of which is Cr, are concurrently formed, to thereby form said recording layer in the laminated structure and said thin film, the primary component of which is Cr.

7. A method of manufacturing a magnetic recording medium according to claim 6, wherein when concurrently forming the respective layers that form said recording layer and the respective layers that constitute said thin film, the primary component of which is Cr, the respective layers to be manufactured in the same chamber are formed with a substantially equal film thickness.

8. A method of manufacturing a magnetic recording medium according to claim 5, wherein a primary component of the substrate is either crystallized glass or amorphous glass.

9. A magnetic recording/reproducing device including a combination of: a magnetic recording medium according to claim 1; a driving section that drives the magnetic recording medium in a recording direction; a magnetic head formed with a recording section and a reproducing section; a head driving section that relatively moves the magnetic head with respect only to one side of the magnetic recording medium; and a recording/reproduction signal processing device that inputs signals to the magnetic head and reproduces output signals from the magnetic head.
